(19) United States
(12) Patent Application Publication
(10) Pub. No.: US 2014/0009553 A1
(43) Pub. Date: Jan. 9, 2014

(54) PRINTING APPARATUS

(71) Applicant: CANON KABUSHIKI KAISHA, Tokyo (JP)

(72) Inventors: Kazuhisa Kawakami, Yokohama-shi (JP); Yasuhito Tsubakimoto, Tokyo (JP); Toshiaki Harada, Kawasaki-shi (JP); Masaya Shimmachi, Kawasaki-shi (JP); Kaneto Tokuyama, Tokyo (JP)

(21) Appl. No.: 13/930,333

(22) Filed: Jun. 28, 2013

(30) Foreign Application Priority Data
Jul. 5, 2012 (JP) 2012-151461

(51) Int. Cl. B41J 2/01

(52) U.S. Cl. CPC B41J 2/01
USPC 347/108

(57) ABSTRACT

A printing apparatus includes a print head configured to discharge ink, a housing in which the print head is provided, the housing having an opening, a cover unit which is openable with respect to the opening, a detection unit configured to detect an opening of the cover unit, and a wall inside the housing arranged between the detection unit and the print head, wherein the wall is configured to establish a separation between a space where the detection unit is located and a space where the print head is located when the cover unit is in a closed state.

### BACKGROUND OF THE INVENTION

1. Field of the Invention

The present disclosure relates to an inkjet printing apparatus.

2. Description of the Related Art

Japanese Patent Application Laid-Open No. 2007-15246 discusses an inkjet printing apparatus that includes a main body having an opening formed thereon, a cover configured to open and close the opening, and a detection unit configured to detect opening and closing operations of the cover. In the inkjet printing apparatus, the detection unit is arranged on the cover. If the detection unit detects that the cover opens up the opening of the main body, ink tanks built in the main body automatically move to the center of the opening. The user can thus easily replace the ink tanks.

The main body of the inkjet printing apparatus also includes a print head for discharging ink, aside from the ink tanks. When the print head discharges ink, ink mist is generated. The generated ink mist floats inside the main body. In the inkjet printing apparatus discussed in Japanese Patent Application Laid-Open No. 2007-15246, the detection unit is exposed to the main body side when the opening of the main body is closed by the cover. The ink mist generated from the print head can thus adhere to the detection unit via the opening. The ink mist adhering to the detection unit may interfere with a stable detection operation.

### SUMMARY OF THE INVENTION

The present disclosure is directed to an inkjet printing apparatus that makes ink mist less likely to adhere to the detection unit which detects opening and closing operations of the cover.

According to an aspect disclosed herein, (same as claim 1)

Further features of the present invention will become apparent from the following description of exemplary embodiments with reference to the attached drawings.

### BRIEF DESCRIPTION OF THE DRAWINGS

FIGS. 1A and 1B are perspective views of an inkjet printing apparatus according to a first exemplary embodiment.

FIGS. 2A, 2B, and 2C are diagrams illustrating a connection form of a cover unit and a main body of the inkjet printing apparatus illustrated in FIGS. 1A and 1B.

FIG. 3 is a plan view illustrating essential components of the main body.

FIG. 4 is an enlarged perspective view illustrating connection portions of the cover unit and the main body.

FIG. 5 is a perspective view illustrating a peripheral area of a detection unit in the main body.

FIGS. 6A and 6B are sectional views illustrating opening and closing operations of the cover unit.

FIG. 7 is a perspective view illustrating a configuration where a plurality of inner wall portions is formed on the main body.

FIG. 8 is a sectional view illustrating essential components of an inkjet printing apparatus according to a second exemplary embodiment.

FIGS. 9A and 9B are side views of the inkjet printing apparatus illustrated in FIG. 8.

FIGS. 10A, 10B, 10C, 10D, 10E, and 10F are diagrams illustrating a configuration different from that illustrated in FIGS. 9A and 9B.

### DESCRIPTION OF THE EMBODIMENTS

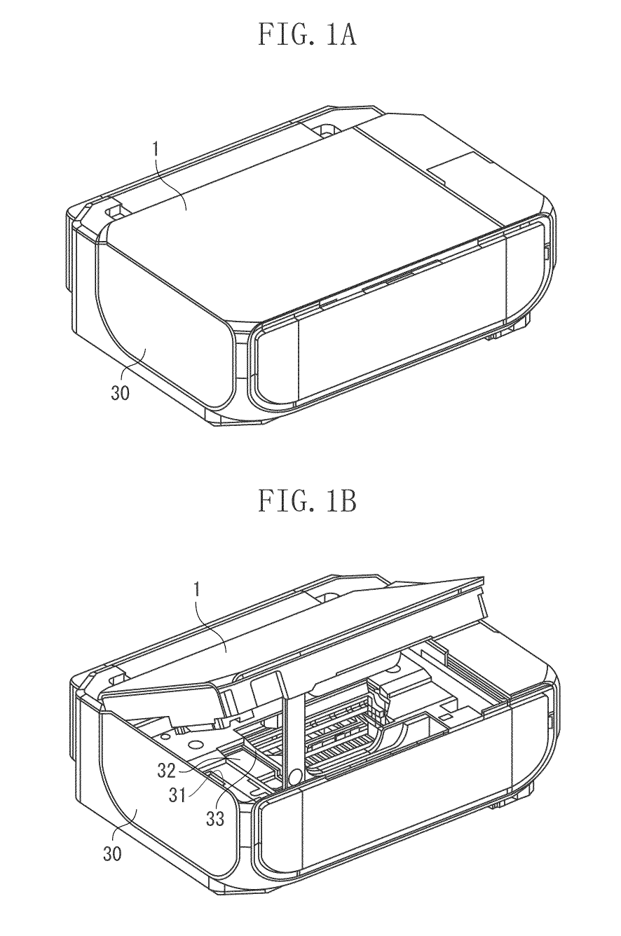

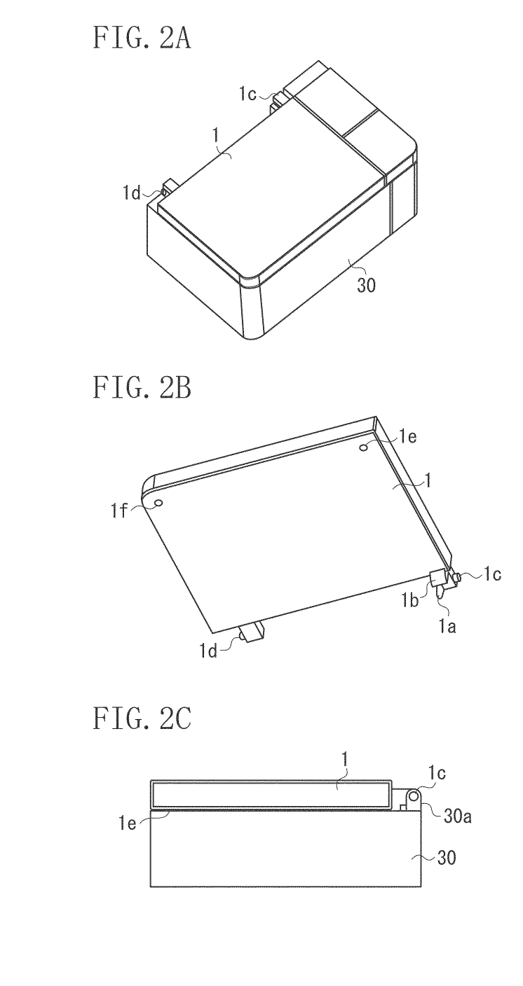

FIGS. 1A and 1B are perspective views of an inkjet printing apparatus according to a first exemplary embodiment. The inkjet printing apparatus includes a cover unit 1 and a main body 30 serving as a housing. The main unit 30 has an opening 31 formed thereon (see FIG. 1B). The cover unit 1 is openable (opens and closes) with respect to the opening 31. FIG. 1A illustrates a closed state where the cover unit 1 closes the opening 31. FIG. 1B illustrates an open state where the cover unit 1 opens up the opening 31. As illustrated in FIG. 1B, the opening 31 has a virtual plane parallel to a horizontal plane. The opening 31 appears and exposes an interior of the inkjet printing apparatus when the cover unit 1 is in the open state. The user can access the interior of the inkjet printing apparatus exposed in the opening 31 to perform maintenance, such as replacement of an ink tank and jamming handling.

The cover unit 1 may include an operation unit including an input button or buttons and a display for the user to operate the inkjet printing apparatus. The cover unit 1 may include a scanner unit, such as a flatbed scanner and a sheet-through scanner, for reading a document.

FIGS. 2A, 2B, and 2C are diagrams illustrating a connection form of the cover unit 1 and the main body 30 in the inkjet printing apparatus illustrated in FIGS. 1A and 1B. FIG. 2A is a perspective view illustrating a state where the cover unit 1 is attached to the main body 30. FIG. 2B is a perspective view of the cover unit 1 as seen from its lower surface (a surface opposed to the main body 30). FIG. 2C is a side view illustrating the state where the cover unit 1 is attached to the main body 30.

As illustrated in FIG. 2B, cylindrical shaft portions 1c and 1d are arranged on a rear side of the cover unit 1. The shaft portions 1c and 1d are supported by bearing portions 30a arranged on the main body 30 (see FIG. 2C). The cover unit 1 rotates about the shaft portions 1c and 1d to open and close the opening 31 (see FIG. 1B) of the main body 30. A protruding member 1a with a tapered shape and a protruding member 1b with a plate shape are arranged near the shaft portion 1c.

As illustrated in FIG. 2B, protrusions 1e and 1f are formed on the lower surface of the cover unit 1. When the cover unit 1 closes the opening 31 of the main body 30, the protrusions 1e and 1f contact the main body 30. The protrusions 1e and 1f determine an orientation of the cover unit 1.

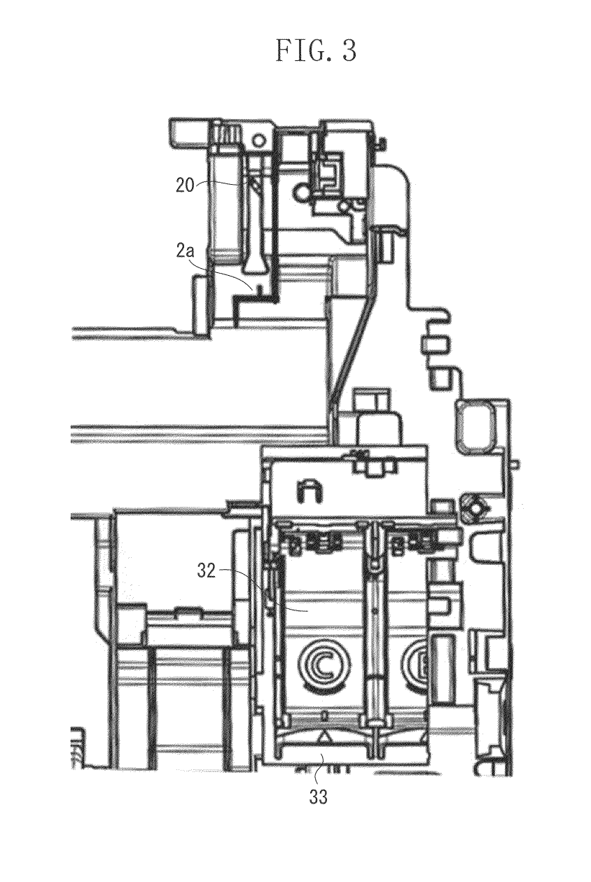

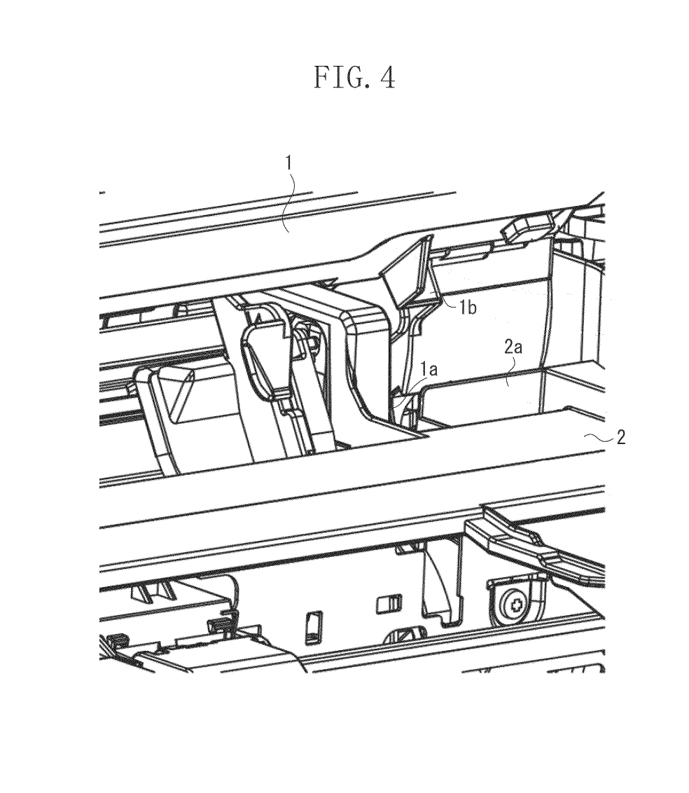

FIG. 3 is a plan view illustrating essential components of the main body 30. FIG. 4 is an enlarged perspective view illustrating connection portions of the cover unit 1 and the main body 30. As illustrated in FIG. 3, the main body 30 includes a detection unit 20, a printing unit 32, and a carriage 33. The detection unit 20 detects opening and closing operations of the cover unit 1. The printing unit 32 discharges ink onto a printing medium. The printing unit 32 is mounted on the carriage 33 which reciprocates in a scanning direction orthogonal to a conveyance direction of the printing medium. The printing unit 32 includes a print head and ink tanks arranged above the print head. The print head includes a plurality of discharge ports, which is arranged in a position opposed to the printing medium and corresponds to a black ink and a plurality of color inks, respectively. FIG. 3 is a view from above, in which only the ink tanks of the printing unit 32 are seen. The print head is hidden under the ink tanks. Note that the printing unit 32 may only include the print head without the ink tanks. In such a configuration, the print head mounted on the carriage 33 may be supplied with ink from ink tanks installed in a different location of the inkjet printing apparatus via tubes.

As illustrated in FIG. 3, an inner wall portion 2a is formed on a frame 2 to be described below, and the printing unit 32 is arranged on a side opposite the detection unit 20 while being separated by the inner wall portion 2a. When the inkjet printing apparatus is horizontally placed, the inner wall portion 2a is located in a position higher than the detection unit 20 in a direction of gravity.

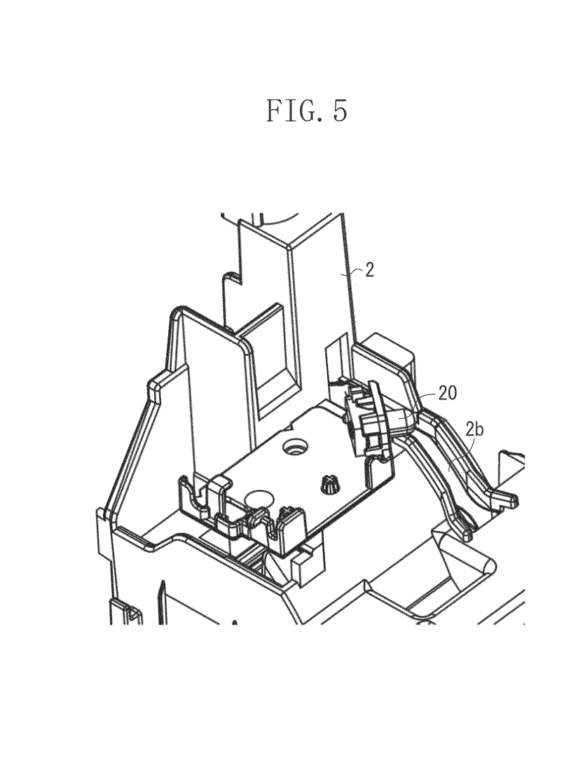

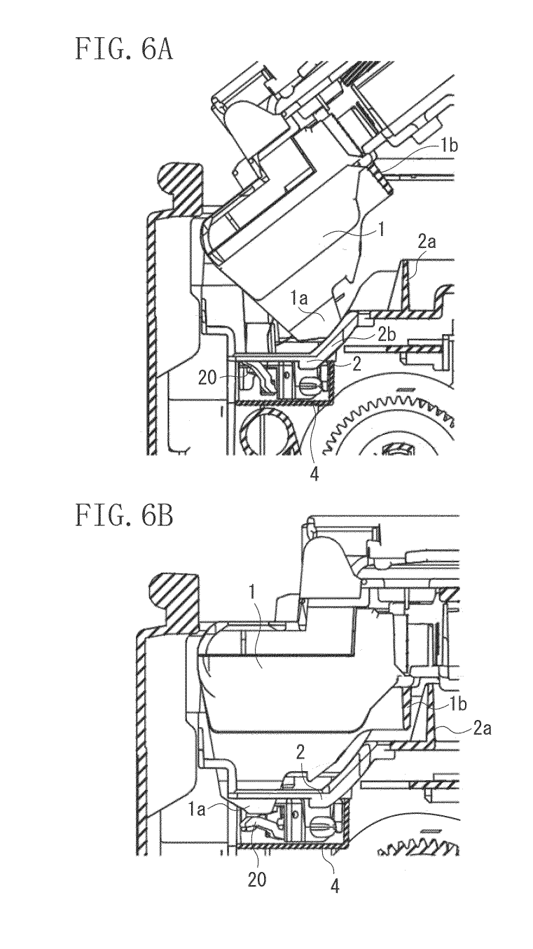

FIG. 5 is a perspective view illustrating a peripheral area of the detection unit 20 in the main body 30. FIGS. 6A and 6B are sectional views illustrating the opening and closing operations of the cover unit 1. FIG. 6A illustrates the open state where the cover unit 1 opens up the opening 31 of the main body 30. FIG. 6B illustrates the closed state where the cover unit 1 closes the opening 31 of the main body 30. While the printing unit 32 is not illustrated in FIGS. 6A and 6B, the printing unit 32 is arranged on the right of the inner wall portion 2a.

The detection unit 20 is located below the bearing portions 30a described above, and is stored in a frame 2, which is made of resin. The detection unit 20 is a leaf switch. A tactical switch or other mechanical switch may be applied to the detection unit 20 aside from a leaf switch. An optical switch such as a photointerrupter may also be applied to the detection unit 20. The switch, whether mechanical or optical, may cause a sensing malfunction or breakdown if a large amount of ink mist adheres to a sensing portion of the switch. A measure for suppress the adhesion will be described below.

In the open state illustrated in FIG. 6A, the detection unit 20 does not contact the cover unit 1. The main body 30 enters a maintenance mode for replacing the ink tanks or for handling a paper jam. To replace the ink tanks, the carriage 33, on which the ink tanks are mounted, moves to a position exposed in the opening 31. In the maintenance mode, the print head does not discharge ink onto a printing medium.

When the main body 30 shifts from the open state illustrated in FIG. 6A to the closed state illustrated in FIG. 6B, the protruding member 1a of the cover unit 1 descends along a hole portion 2b formed in the frame 2 and contacts the detection unit 20. The protruding member 1a displaces the detection unit 20 downward from the position illustrated in FIG. 6A. The detection unit 20 detects the closed state by the displacement. In response to the detection of the detection unit 20, the print head enters a state capable of discharging ink onto a printing medium. In the closed state illustrated in FIG. 6B, the protruding member 1b arranged on the cover unit 1 is opposed to the inner wall portion 2a on the detection unit side in parallel.

In the foregoing configuration, when the print head of the printing unit 32 discharges ink, generated ink mist may float over to the side of the detection unit 20. The inner wall portion 2a lying between the print head and the detection unit 20 is located in a position higher than the detection unit 20. With such a configuration, most of the ink mist generated from the print head is blocked by the inner wall portion 2a. As a result, the ink mist is less likely to intrude into the space where the detection unit 20 is.

Part of the ink mist can possibly intrude into the side of the detection unit 20 via a gap between a top end of the inner wall portion 2a and the cover unit 1. However, the cover unit 1 includes the protruding member 1b of plate shape opposed to the inner wall portion 2a on the side of the detection unit 20. The ink mist intruding via the gap between the top end of the inner wall portion 2a and the cover unit 1 is thus blocked by the protruding member 1b. This improves the effect for suppressing the intrusion of the ink mist into the space where the detection unit 20 is.

The protruding member 1b may be arranged on the cover unit 1 to be opposed to the inner wall portion 2a on the print head side. In such a case, most of the ink mist generated from the print head is blocked by the protruding member 1b. Part of the ink mist can possibly intrude via a gap between a bottom end of the protruding member 1b and the main body 30. Such ink mist is blocked by the inner wall portion 2a. Consequently, the effect for suppressing the intrusion of the ink mist into the side of the detection unit 20 improves like when the protruding member 1b is opposed to the inner wall portion 2a on the side of the detection unit 20.

As described above, in the closed state where the cover unit 1 is closed, the inner wall portion 2a separates the space where the detection unit 20 is located from the space where the print head side of the printing unit 32 is located. This significantly reduces the adhesion of ink mist to the detection unit 20, so that malfunctions and breakage of the detection unit 20 are significantly suppressed. As employed herein, to “separate” does not refer to hermetic separation of spaces in a strict sense, but may cover a somewhat open form as long as the separation has a blocking effect for reducing the intrusion of ink mist. As employed herein, such an interpretation is applied to “separate.”

According to the foregoing configuration, in the open state, the user is not able to directly touch the detection unit 20 via the opening 31. This can prevent the user from accidentally pressing the detection unit 20 firmly to break the detection unit 20 when the user handles a paper jam. In addition, the formation of the inner wall portion 2a on the main body 30 increases a creeping distance from outside to the detection unit 20. Electrostatic breakdown of the detection unit 20 can thus be suppressed.

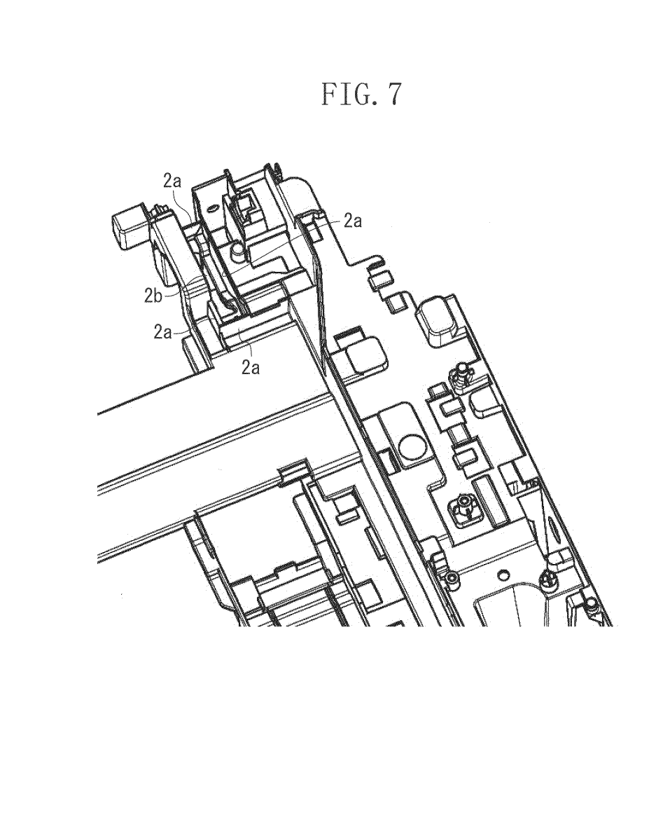

FIG. 7 is a perspective view illustrating a configuration where a plurality of inner wall portions 2a is formed on the main body 30. In FIG. 7, the plurality of inner wall portions 2a is formed to surround the hole portion 2b. The detection unit 20 is arranged under the hole portion 2b. As a result, the detection unit 20 is surrounded by the plurality of inner wall portions 2a. Such a configuration improves the hermeticity of the space where the detection unit 20 is located, so that the effect for suppressing the intrusion of ink mist improves further.

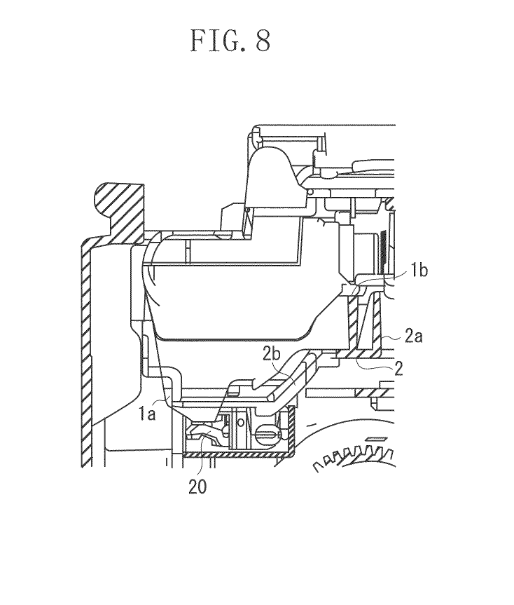

FIG. 8 is a sectional view illustrating essential components of an inkjet printing apparatus according to a second exemplary embodiment. Similar components to those described in the first exemplary embodiment will be indicated by the same reference numerals. A detailed description thereof will not be repeated.

FIG. 8 illustrates the inkjet printing apparatus in a closed state. In the closed state, the bottom end of the protruding member 1b arranged on the cover unit 1 contacts the frame 2 of the main body 30. Since the gap between the protruding member 1b and the frame 2 is smaller than that in the first exemplary embodiment, the intrusion of ink mist via the gap into the space where the detection unit 20 is located can be suppressed more reliably than in the first exemplary embodiment.

The configuration that the bottom end of the protruding member 1b contacts the frame 2 is not restrictive. A configuration such that the top end of the inner wall portion 2a arranged on the frame 2 contacts the cover unit 1 may be employed instead. Alternatively, a configuration such that the bottom end of the protruding member 1b and the top end of the inner wall portion 2b both contacts the cover unit 1 may be employed.

The second exemplary embodiment includes a hinge mechanism that allows the cover unit 1 to open and close the main body 30. The hinge mechanism has play that allows the cover unit 1 to move in a vertical direction with respect to the opening 31. A specific structure is described below.

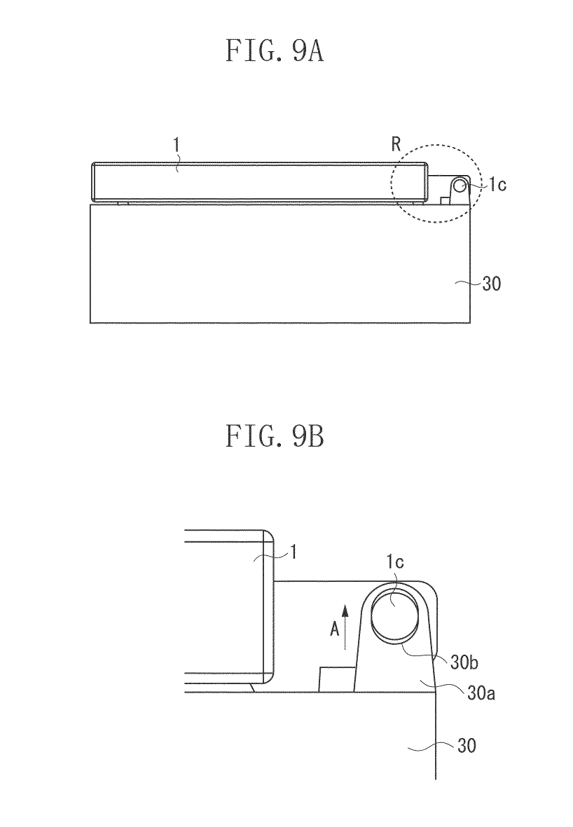

FIGS. 9A and 9B are side views of the inkjet printing apparatus illustrated in FIG. 8. FIG. 9A is a side view of the entire inkjet printing apparatus. FIG. 9B is an enlarged view of a region R surrounded by the dotted line illustrated in FIG. 9A.

As illustrated in FIG. 9B, the cover unit 1 includes a cylindrical shaft portion 1c. The shaft portion 1c is supported by a bearing portion 30a arranged on the main body 30. The shaft portion 1c and the bearing portion 30a constitute the hinge mechanism. The bearing portion 30a has an elliptical hole portion 30b into which the shaft portion 1c is inserted. The major axis of the hole portion 30b is in a direction A intersecting (in this example, perpendicular to; see the arrow in FIG. 9B) the virtual plane of the opening 31 (see FIG. 1B) of the main body 30. Such a hinge mechanism allows the cover unit 1 to rotate about the shaft portion 1c with play for some movement in the direction A.

Depending on dimension errors in the length of the protruding member 1b arranged on the cover unit 1, the cover unit 1 may fail to enter the closed state (the cover unit 1 may be oblique to the main body 30) when the protruding member 1b contacts the frame 2. The hole portion 30b of the bearing portion 30a then enables a fine adjustment to the position of the shaft portion 1 (allows the cover unit 1 to ascend) to secure the closed state. Alternatively, the bearing portion 30a itself may be configured to be movable in the foregoing direction A.

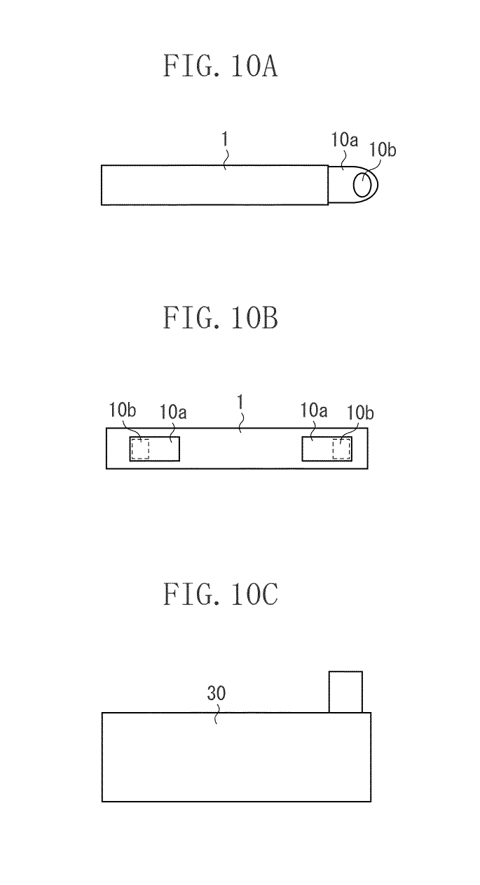

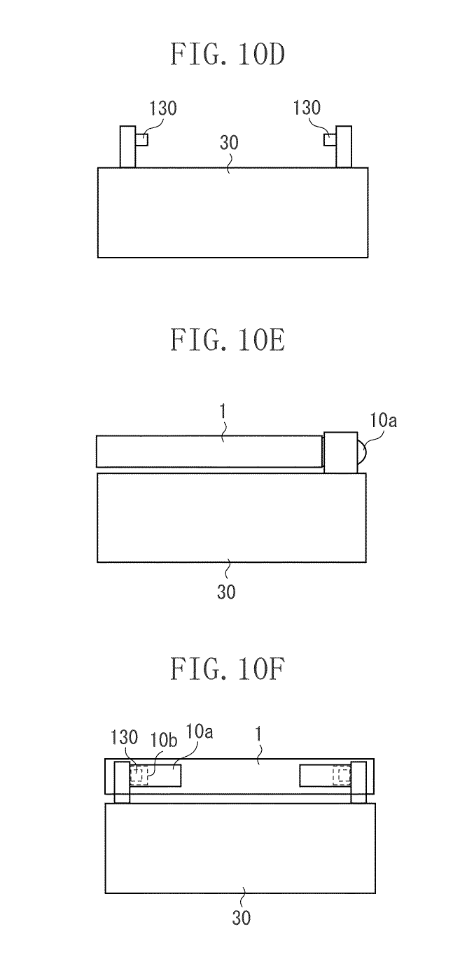

FIGS. 10A, 10B, 10C, 10D, 10E, and 10F are diagrams illustrating a configuration concerning the connection between the cover unit 1 and the main body 30, different from that illustrated in FIGS. 9A and 9B. FIG. 10A is a side vide of the cover unit 1. FIG. 10B is a rear view of the cover unit 1. FIG. 10C is a side view of the main body 30. FIG. 10D is a rear view of the main body 30. FIG. 10E is a side view illustrating a state where the cover unit 1 is attached to the main body 30. FIG. 10F is a rear view illustrating the state where the cover unit 1 is attached to the main body 30.

As illustrated in FIGS. 10A and 10B, bearing portions 10a similar to the bearing portion 30a are arranged on the rear surface of the cover unit 1. The bearing portions 10a have an elliptical hole portion 10b. As illustrated in FIGS. 10C and 10D, cylindrical shaft portions 130 similar to the shaft portion 1c are arrange on top of the main body 30. The shaft portions 130 and the bearing portions 10a constitute a hinge mechanism. The shaft portions 130 are inserted into the hole portions 10b in the bearing portions 10a (see FIG. 10F). With such a hinge mechanism, the cover unit 1 can rotate about the shaft portions 130 with play that allows movement in a direction intersecting (in this example, perpendicular to) the virtual plane of the opening 31. As a result, the position of the cover unit 1 can be adjusted as with the configuration illustrated in FIGS. 9A and 9B.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-151461 filed Jul. 5, 2012, which is hereby incorporated by reference herein in its entirety.

What is claimed is:

1. A printing apparatus comprising:
a print head configured to discharge ink;
a housing in which the print head is provided, the housing having an opening;
a cover unit which is openable with respect to the opening;
a detection unit configured to detect an opening of the cover unit; and
a wall inside the housing arranged between the detection unit and the print head,
wherein the wall is configured to establish a separation between a space where the detection unit is located and a space where the print head is located when the cover unit is in a closed state.

2. The printing apparatus according to claim 1, wherein the cover unit includes a protruding portion having a plate shape opposite the wall on a side of the detection unit or a side of the print head with respect to the wall when the cover unit is in the closed state.

3. The printing apparatus according to claim 2, wherein an end of the protruding portion is configured to contact the housing when the cover unit is in the closed state.

4. The printing apparatus according to claim 1, wherein a part of the wall is configured to contact the cover unit when the cover unit is in the closed state.

5. The printing apparatus according to claim 1, further comprising a hinge mechanism configured to allow the cover unit to be rotatable,
wherein the hinge mechanism has a play that allows the cover unit to move in a direction intersecting with a virtual plane of the opening.

6. The printing apparatus according to claim 5, wherein the hinge mechanism includes a cylindrical shaft provided on the cover unit and a bearing provided on the housing, and
wherein the bearing has an elliptical hole into which the shaft is inserted to allow movement of the cover unit in the direction intersecting with the virtual plane of the opening.

7. The printing apparatus according to claim 5, wherein the hinge mechanism includes a cylindrical shaft provided on the housing and a bearing provided on the cover unit, and
wherein the bearing has an elliptical hole into which the shaft is inserted to allow movement of the cover unit in the direction intersecting with the virtual plane of the opening.

8. The printing apparatus according to claim 1, wherein a plurality of the walls are formed to surround the detection unit.

9. The printing apparatus according to claim 1, wherein the cover unit is provided with an operation unit of the printing apparatus.

10. The printing apparatus according to claim 1, wherein the cover unit is provided with a scanner unit.
